(19) United States
(12) Patent Application Publication
(10) Pub. No.: US 2021/0379877 A1
(43) Pub. Date: Dec. 9, 2021

(54) POLYROTAXANE COMPOSITE FORMED BODY AND PRODUCTION METHOD THEREFOR

(71) Applicants: OSAKA UNIVERSITY, Suita-shi, Osaka (JP); TOYODA GOSEI CO., LTD., Kiyosu-shi, Aichi-ken (JP)

(72) Inventors: Shinji TAKANO, Kiyosu-shi, Aichi-ken (JP); Koya MATSUNO, Kiyosu-shi, Aichi-ken (JP); Yoshinori NAGAMORI, Kiyosu-shi, Aichi-ken (JP); Akira HARADA, Suita-shi, Osaka (JP); Yoshinori TAKASHIMA, Suita-shi, Osaka (JP); Motofumi OSAKI, Suita-shi, Osaka (JP); Katsunari INOUE, Kashiwashi, Chiba (JP)

(21) Appl. No.: 17/285,637

(22) PCT Filed: Oct. 15, 2019
(86) PCT No.: PCT/JP2019/040385

§ 371 Date: Apr. 15, 2021

(30) Foreign Application Priority Data
Oct. 19, 2018 (JP) 2018-197997

(51) Int. Cl. B32B 27/28; C08J 7/12; B32B 27/08; B32B 37/10; B32B 37/06

(52) U.S. Cl. CPC B32B 27/28; C08J 7/123; B32B 27/08; B32B 37/10; B32B 2310/14; C08J 2387/00; C08J 2483/04; B32B 2307/202; B32B 37/06

(57) ABSTRACT

To provide a polyrotaxane composite formed body produced by strong bonding between a crosslinked polyrotaxane formed body and an elastomer formed body without intervention of an adhesive.

Provided is a method for producing a polyrotaxane composite formed body, the method including subjecting a surface of a crosslinked polyrotaxane formed body and a surface of an elastomer formed body to plasma treatment, and pressure joining the treated surfaces together, to thereby bond the formed bodies. Also provided is a polyrotaxane composite formed body including a crosslinked polyrotaxane formed body and an elastomer formed body, wherein these formed bodies are directly bonded together without being intermingled with each other in the absence of an adhesive layer between the formed bodies, an oxygen-rich layer is present between the bonding surfaces of the formed bodies, and the formed bodies exhibit a peel strength of 1 N/m or more.

### CROSS REFERENCE TO RELATED APPLICATIONS

This application is a U.S. national stage application of PCT/JP2019/040385 filed on Oct. 15, 2019, and claims priority to Japanese Patent Application No. 2018-197997 filed on Oct. 19, 2018, the disclosures of which are incorporated herein by reference.

### TECHNICAL FIELD

The present invention relates to a polyrotaxane composite formed body produced by bonding between a crosslinked polyrotaxane formed body and an elastomer formed body, and a method for producing the polyrotaxane composite formed body.

### BACKGROUND

A polyrotaxane is a molecular assembly having a structure wherein a linear molecule slidably penetrates through a cyclic molecule, and the cyclic molecule is prevented from being removed by blocking groups disposed at both ends of the linear molecule (Patent Document 1). A polyrotaxane is also called “slide-ring material.” A variety of cyclic molecules and linear molecules have been known. A composition containing a polyrotaxane is expected to be used in various applications because of the viscoelasticity of the composition.

As described in Patent Documents 2 to 5, a crosslinked polyrotaxane has high dielectric constant and unique dynamic characteristics (e.g., viscoelasticity) and thus is expected as a material for actuators or sensors. However, there has arisen a problem that a crosslinked polyrotaxane formed body is difficult to bond to an elastomer formed body used for an electrode layer, resulting in failure to achieve a high bonding strength.

In a layered actuator produced by alternate stacking of crosslinked polyrotaxane formed bodies and elastomer formed bodies as shown in, for example, FIG. 5 of Patent Document 4, a tensile stress is applied between layers of the actuator during operation due to contraction of the crosslinked polyrotaxane formed bodies. Thus, each layer is required to have a bonding strength enough to resist the tensile stress. However, no finding has been given on the bonding strength between the crosslinked polyrotaxane formed body and the elastomer formed body, and there has not yet been established an effective method or member for bonding these formed bodies so as to resist a high tensile stress caused by large deformation of the crosslinked polyrotaxane formed body. Thus, a higher bonding strength has been demanded.

The elastomer bonding is generally performed by a method using an adhesive, and the first thing that should be taken into account is to find an adhesive suitable for the crosslinked polyrotaxane formed body and the elastomer formed body. However, even if such an adhesive is found out, the presence of the adhesive between the crosslinked polyrotaxane formed body and the elastomer formed body may cause the following problems: (A) an increase in the thickness of the layered body; (B) a loss in the amount of displacement in an actuator or a sensor due to restriction of the movement of the polyrotaxane formed body by the adhesive layer; and (C) a decrease in capacitance in the actuator or the sensor.

### PATENT DOCUMENTS

Patent Document 1: International Publication WO 2005/080469
Patent Document 2: International Publication WO 2008/108411
Patent Document 3: Japanese Unexamined Patent Application Publication No. 2015-029406 (JP 2015-029406 A)
Patent Document 4: Japanese Unexamined Patent Application Publication No. 2012-65426 (JP 2012-65426 A)
Patent Document 5: Japanese Unexamined Patent Application Publication No. 2017-66318 (JP 2017-66318 A)

### SUMMARY

In view of the foregoing, an object of the present invention is to provide a polyrotaxane composite formed body produced by strong bonding between a crosslinked polyrotaxane formed body and an elastomer formed body without intervention of an adhesive.

[1] Method for Producing Polyrotaxane Composite Formed Body

The present invention provides a method for producing a polyrotaxane composite formed body, the method being characterized by comprising subjecting a surface of a crosslinked polyrotaxane formed body and a surface of an elastomer formed body to plasma treatment, and pressure joining the treated surfaces together, to thereby bond the formed bodies.

<Effects>

When a surface of a crosslinked polyrotaxane formed body and a surface of an elastomer formed body are subjected to plasma treatment, both the treated surfaces are modified with a radical-containing high-affinity functional group. X-ray photoelectron spectroscopy (XPS) analysis of the treated surfaces has indicated that the surfaces are modified with a hydroxy group; i.e., a high-affinity functional group. Thus, the treated surfaces exhibit high surface energy (chemical and physical activities). Pressure joining of the treated surfaces exhibiting high surface energy stabilizes the joined surfaces, to thereby generate a high bonding strength therebetween because of the thermodynamic gain.

Microscopically, the radical-containing high-affinity functional group generated on the treated surface of the crosslinked polyrotaxane formed body is bonded to the high-affinity functional group of the elastomer formed body via an intermolecular interaction such as covalent bonding or hydrogen bonding. These formed bodies are integrated at the molecular level, and thus a very high bonding strength is achieved.

The modification with a high-affinity functional group (in particular, a hydroxy group) is probably attributed to both or either of the following presumed mechanisms (1) and (2). XPS analysis of the treated surfaces has indicated that the proportion of oxygen attributed to the hydroxy group increases after the treatment.

(1) Activated nitrogen activates oxygen in air, and the activated oxygen reacts with the surface of the material, to thereby provide the surface with a hydroxy group.

(2) Activated nitrogen activates the surface of the material, and the activated surface reacts with oxygen, to thereby provide the surface with a hydroxy group.

As described above, the crosslinked polyrotaxane formed body can be strongly bonded to the elastomer formed body. Thus, when the polyrotaxane composite formed body is, for example, a layered actuator produced by alternate stacking of crosslinked polyrotaxane formed bodies and elastomer formed bodies, the actuator can resist a tensile stress applied between the layers during operation due to contraction of the crosslinked polyrotaxane formed bodies, resulting in reduced layer peeling.

The absence of an adhesive layer between the crosslinked polyrotaxane formed body and the elastomer formed body is more advantageous than the case of the presence of an adhesive layer between these formed bodies in terms of (A) a decrease in the thickness of the polyrotaxane composite formed body; (B) no loss in the amount of displacement in an actuator or a sensor because of the absence of an adhesive layer that restricts the movement of the crosslinked polyrotaxane formed body; and (C) an increase in capacitance in the actuator or the sensor.

Since the crosslinked polyrotaxane formed body is not fuse-bonded to the elastomer formed body, these formed bodies do not intermingle with each other.

[2] Polyrotaxane Composite Formed Body of the Invention

[2-1] A polyrotaxane composite formed body comprising a crosslinked polyrotaxane formed body and an elastomer formed body, wherein these formed bodies are directly bonded together without being intermingled with each other in the absence of an adhesive layer between the formed bodies, an oxygen-rich layer is present between the bonding surfaces of the formed bodies, and the formed bodies exhibit a peel strength of 1 N/m or more.

XPS analysis has indicated that the oxygen-rich layer is derived from a highly active or highly polar oxygen-containing functional group, mainly from a hydroxy group generated during plasma treatment.

The upper limit of the peel strength is not particularly determined, but is probably 20 N/m.

[2-2] A polyrotaxane composite formed body comprising a crosslinked polyrotaxane formed body and an elastomer formed body, wherein these formed bodies are directly bonded together without being intermingled with each other in the absence of an adhesive layer between the formed bodies, the crosslinked polyrotaxane formed body is modified with a high-affinity functional group, the elastomer formed body is modified with a high-affinity functional group, and the high-affinity functional groups are bonded to each other by covalent bonding or intermolecular interaction at the bonding surfaces of the formed bodies.

The present invention can provide a polyrotaxane composite formed body produced by strong bonding between a crosslinked polyrotaxane formed body and an elastomer formed body without intervention of an adhesive.

### BRIEF DESCRIPTION OF THE DRAWINGS

FIG. 1A is a side view illustrating a crosslinked polyrotaxane formed body prepared in Examples, and plasma treatment of the formed body, FIG. 1B is a side view illustrating an elastomer formed body prepared in the Examples, and plasma treatment of the formed body, FIG. 1C is a side view of a body prepared by abutting the crosslinked polyrotaxane formed body to the elastomer formed body, and FIG. 1D is a side view illustrating pressure joining of the crosslinked polyrotaxane formed body and the elastomer formed body;

FIG. 2 is an explanatory view showing a dielectric breakdown test performed on a crosslinked polyrotaxane formed body;

FIG. 3 is an explanatory view showing a peel test performed on a polyrotaxane composite formed body; and

FIG. 4 is a cross-sectional view of an actuator prepared from polyrotaxane composite formed bodies.

### DETAILED DESCRIPTION

[1] Crosslinked Polyrotaxane Formed Body

A crosslinked polyrotaxane formed body is composed of a crosslinked polyrotaxane, and may contain a component other than a polyrotaxane. The crosslinked polyrotaxane is not limited to one containing a specific cyclic molecule, linear molecule, blocking group, and crosslinking agent.

Examples of the cyclic molecule include cyclodextrin, crown ether, cyclophane, calixarene, cucurbituril, and cyclic amide.

Examples of the linear molecule include polyethers such as polyethylene glycol, polypropylene glycol, and polytetrahydrofuran, polyesters such as polylactic acid, polyamides such as 6-nylon, diene polymers such as polyisoprene and polybutadiene, polyethylene, polypropylene, vinyl polymers such as polyvinyl alcohol, polyvinyl methyl ether, and polyisobutylene, and polydimethylsiloxane.

Examples of the blocking group include dinitrophenyl group, cyclodextrin group, adamantane group, trityl group, fluorescein group, pyrene group, substituted benzene group (the substituent may be, for example, alkyl, alkyloxy, hydroxy, halogen, cyano, sulfonyl, carboxyl, amino, or phenyl), optionally substituted polynuclear aromatic group (the substituent may be, for example, the same as those described above), and steroid group.

Examples of the crosslinking agent include cyanuric chloride, trimesoyl chloride, terephthaloyl chloride, epichlorohydrin, dibromobenzene, glutaraldehyde, aliphatic polyfunctional isocyanate, aromatic polyfunctional isocyanate, tolylene diisocyanate, hexamethylene diisocyanate, divinyl sulfone, 1,1′-carbonyldiimidazole, alkoxysilanes and derivatives thereof, and polysiloxane-containing block copolymers (e.g., polycaprolactone-polysiloxane block copolymers, polyadipate-polysiloxane block copolymers, and polyethylene glycol-polysiloxane block copolymers).

Currently, the commonest polyrotaxane contains cyclodextrin as a cyclic molecule and polyethylene glycol as a linear molecule.

Examples of the form of the polyrotaxane formed body include, but are not particularly limited to, film, wire, strip, ring, bar, and lump. A polyrotaxane formed body in the form of, for example, film may be applied onto another base material.

[2] Elastomer Formed Body

An elastomer formed body is composed of an elastomer, and may contain a component other than an elastomer.

Examples of the elastomer include, but are not particularly limited to, silicone elastomer, styrenic thermoplastic elastomer, natural rubber, nitrile rubber, acrylic rubber, urethane rubber, urea rubber, fluororubber, and crosslinked polyrotaxane. Examples of the crosslinked polyrotaxane include the same as those described above.

Examples of the form of the elastomer formed body include, but are not particularly limited to, film, wire, strip, ring, bar, and lump. An elastomer formed body in the form of, for example, film may be applied onto another base material.

The elastomer formed body may have electrical conductivity, and the polyrotaxane composite formed body may be, for example, an actuator or a sensor. Electrical conductivity can be imparted to the elastomer formed body by, for example, dispersing electrically conductive particles (e.g., carbon black, carbon nanotube, or platinum) into the elastomer formed body.

[3] Plasma Treatment

No particular limitation is imposed on the plasma treatment, and it may be, for example, atmospheric pressure plasma or low pressure plasma treatment. The low pressure plasma treatment requires the use of a hermetically sealed low pressure chamber. In contrast, the atmospheric pressure plasma treatment is preferred in view that it does not require the use of a low pressure chamber.

Examples of the plasma gas used for the plasma treatment include, but are not particularly limited to, air, nitrogen, a mixture of nitrogen and hydrogen, and argon. As shown in Tables 1 and 2 and Examples 1 to 15 below, plasma gas containing substantially no oxygen is preferably used in view of suppression of a decrease in the dielectric breakdown field strength of the crosslinked polyrotaxane formed body by the plasma treatment. Plasma gas containing oxygen in an amount of 0.1% by volume or less is obviously considered as plasma gas containing substantially no oxygen.

Water contact angle is an index for the degree of plasma treatment; i.e., the smaller the water contact angle, the higher the degree of plasma treatment. The degree of plasma treatment correlates with bonding strength.

On the basis of Tables 1 and 2 and Examples 1 to 15 shown below, the surface of the plasma-treated crosslinked polyrotaxane formed body exhibits a water contact angle of preferably 90° or less, more preferably 750 or less. Still more preferably, the water contact angle is 90° or less, and the aforementioned peel strength is 1 N/m or more. Much more preferably, the water contact angle is 75° or less, and the aforementioned peel strength is 4 N/m or more.

The surface of the plasma-treated elastomer formed body exhibits a water contact angle of preferably 92° or less, more preferably 70° or less.

[4] Heating During Pressure Joining

Heating is preferably performed simultaneously with pressure joining, since the heating promotes bonding between the high-affinity functional group provided on the plasma-treated crosslinked polyrotaxane formed body and the high-affinity functional group provided on the plasma-treated elastomer formed body.

The heating temperature is preferably 50° C. or higher, more preferably 80° C. or higher. However, the heating temperature is required to be lower than both of the melting point of the crosslinked polyrotaxane formed body and the melting point of the (thermoplastic) elastomer formed body. Preferably, the heating temperature is lower than either of the melting points. When the heating temperature is higher than both of the melting points, the crosslinked polyrotaxane formed body intermingles with the elastomer formed body; i.e., these formed bodies are fuse-bonded with each other, which differs from the bonding proposed by the present invention.

[5] Applications

No particular limitation is imposed on the application of the polyrotaxane composite formed body. One exemplary application is an electronic component wherein the crosslinked polyrotaxane formed body serves as a dielectric body and the electrically conductive elastomer formed body serves as an electrode. Examples of the electronic component include an actuator and a sensor.

### Examples

Embodiments of the present invention; i.e., examples of the polyrotaxane composite formed body of the invention will be described in the following order. The present invention should not be construed as being limited to the examples.

### <1> Preparation of Crosslinked Polyrotaxane Formed Body

### <2> Preparation of Elastomer Formed Body

### <3> Plasma Treatment of Crosslinked Polyrotaxane Formed Body and Elastomer Formed Body and Measurement of Contact Angle

<4> Measurement of Dielectric Breakdown Field Strength of Crosslinked Polyrotaxane Formed Body before and after Plasma Treatment

### <5> Bonding by Pressure Joining of Crosslinked Polyrotaxane Formed Body and Elastomer Formed Body

### <6> Measurement of Peel Strength of Crosslinked Polyrotaxane Formed Body and Elastomer Formed Body

### <7> Plasma Treatment of Crosslinked Polyrotaxane Formed Body and Additional Crosslinked Polyrotaxane Formed Body and Measurement of Contact Angle

### <8> Bonding by Pressure Joining of Crosslinked Polyrotaxane Formed Body and Additional Crosslinked Polyrotaxane Formed Body

### <9> Measurement of Peel Strength of Crosslinked Polyrotaxane Formed Body and Additional Crosslinked Polyrotaxane Formed Body

### <10> Preparation of Actuator

<1> Preparation of Crosslinked Polyrotaxane Formed Body

A polyrotaxane composition was prepared in the same manner as in Example 1 of Patent Document 5.

Firstly, there were prepared polyrotaxane A, block copolymer B containing polysiloxane, and polymer C not containing polysiloxane as disclosed in Patent Document 5.

Specifically, polyrotaxane A contains cyclodextrin as a cyclic molecule and polyethylene glycol as a linear molecule, wherein blocking groups are disposed at both ends of the linear molecule. Polyrotaxane A of the Examples further contains a caprolactone group for achieving solubility and compatibility.

Block copolymer B containing polysiloxane is incorporated for improving moisture resistance by polysiloxane (silicone component). Specifically, block copolymer B is a polycaprolactone-polydimethylsiloxane-polycaprolactone block copolymer having end-blocked isocyanate groups. Addition of block copolymer B is optional.

Polymer C not containing polysiloxane has high compatibility with polyrotaxane, and is incorporated for achieving high dielectric constant and low elasticity. Specifically, polymer C is polypropylene glycol having end-blocked isocyanate groups. Addition of polymer C is optional.

These components and other components were added in amounts described below (represented by “parts by mass”), and the resultant mixture was stirred and thoroughly defoamed, to thereby prepare a polyrotaxane composition solution.

| | |
|---|---|
| Polyrotaxane A | 10 |
| Polysiloxane block copolymer B | 4.9 |
| Polymer C | 10.5 |
| Polypropylene glycol diol | 4.7 |
| Methyl cellosolve | 25.9 |
| Dibutyltin dilaurate | 0.014 |
| DBL-C31 (available from GELEST) | 0.14 |
| IRGANOX 1726 (available from BASF) | 0.42 |

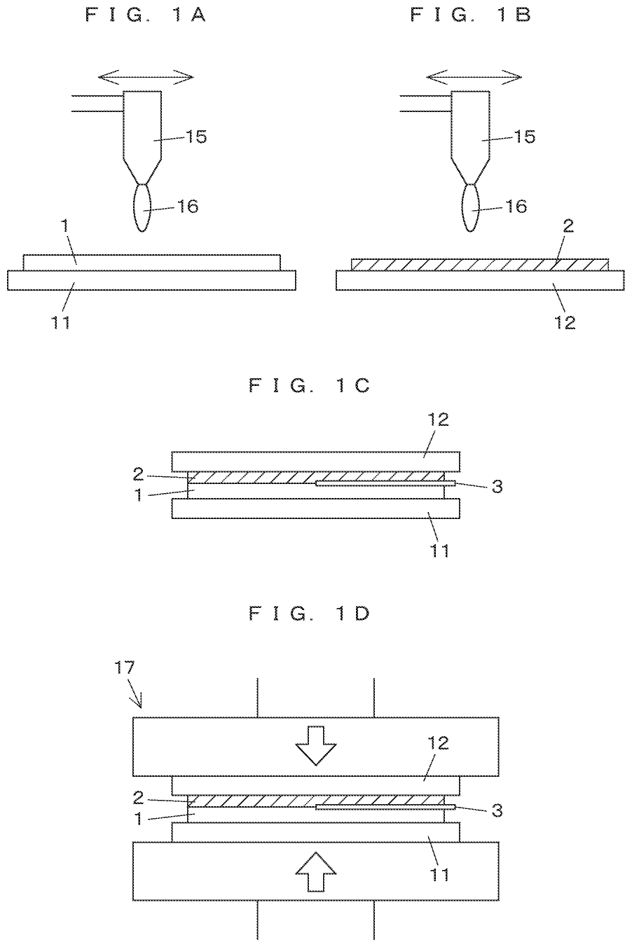

As shown in FIG. 1A, the aforementioned polyrotaxane composition solution was applied by slit die coating onto a polyethylene terephthalate (PET) sheet 11 (thickness: 75 μm) for prevention of elongation, to thereby form a polyrotaxane formed body 1 (film) having a thickness of 50 μm.

Subsequently, the polyrotaxane formed body 1 having the PET sheet 11 was crosslinked and cured in an oven at 130° C. under reduced pressure for five hours, to thereby form a crosslinked polyrotaxane formed body 1.

<2> Preparation of Elastomer Formed Body

Silicone elastomer and other components were added in amounts described below (represented by “parts by mass”), and the resultant mixture was stirred and thoroughly defoamed, to thereby prepare an elastomer composition solution. Carbon particles are added for imparting electrical conductivity to an elastomer formed body.

| | |
|---|---|
| Silicone elastomer | 10 |
| Organic solvent (heptane) | 300 |
| Carbon particles (ketjen black) | 1 |

As shown in FIG. 1B, the aforementioned elastomer composition solution was applied by slit die coating onto a PET sheet 12 (thickness: 75 μm) for prevention of elongation, to thereby form an elastomer formed body 2 (film) having a thickness of 20 μm.

Subsequently, the elastomer formed body 2 having the PET sheet 12 was crosslinked and cured in an oven at 100° C. under reduced pressure for 24 hours.

<3> Plasma Treatment of Crosslinked Polyrotaxane Formed Body and Elastomer Formed Body and Measurement of Contact Angle

Plasma treatment was performed on a surface of the crosslinked polyrotaxane formed body 1 having the PET sheet 11 prepared in <1> above and a surface of the elastomer formed body 2 having the PET sheet 12 prepared in <2> above. The plasma treatment was performed with atmospheric pressure plasma requiring no use of a low pressure chamber.

As shown in FIG. 1A, while specific plasma gas 16 was applied through the outlet of a plasma jet nozzle 15 to the surface of the crosslinked polyrotaxane formed body 1, the plasma jet nozzle 15 was scanned (moved) along the surface, to thereby treat the surface of the crosslinked polyrotaxane formed body 1 with the plasma.

As shown in FIG. 1B, while the specific plasma gas 16 was applied through the outlet of the plasma jet nozzle 15 to the surface of the elastomer formed body 2, the plasma jet nozzle 15 was scanned (moved) along the surface, to thereby treat the surface of the elastomer formed body 2 with the plasma.

As shown in Table 1 below, Examples 1 to 13 wherein both of the formed bodies 1 and 2 were subjected to plasma treatment (the type of plasma gas and the degree of plasma treatment were varied) were compared with Comparative Examples 1 to 10 wherein either or both of the formed bodies 1 and 2 were not subjected to plasma treatment (in Comparative Examples 8 to 10, UV treatment was performed instead of plasma treatment).

The type of plasma gas was air, nitrogen (N₂) (99.99%), a mixture of nitrogen (N₂) (975) and hydrogen (H2) (3%), or argon (Ar).

The degree of plasma treatment was varied by changing the rate of plasma gas application and the scanning speed of the plasma jet nozzle (treatment time).

TABLE 1

| | | Surface Modification Treatment | | | | | | |
|---|---|---|---|---|---|---|---|---|
| | | Crosslinked | | | | Performance | | |
| | | Polyrotaxane | Elastomer | | | Rate of Reduction in | | |
| | | Formed Body | Formed Body | | | Dielectric Breakdown | | |
| | | (Upper: Type of | (Upper: Type of | Water Contact Angle | | Field Strength of | | |
| | | Treatment | Treatment | Crosslinked | | Crosslinked | | |
| | | Lower: Type of | Lower: Type of | Polyrotaxane | Elastomer | Polyrotaxane | Peel | |
| | | Gas, etc.) | Gas, etc.) | Formed Body | Formed Body | Formed Body | Strength | |
| Comparative | 1 | Untreated | Untreated | 92.1° | 96.3° | 0% | 0 | N/m |
| Example | 2 | Untreated | Plasma treatment | 92.1° | 50.5° | 0% | 0 | N/m |
| | | | Air | | | | | |
| | 3 | Untreated | Plasma treatment | 92.1° | 44.3° | 0% | 0 | N/m |
| | | | N₂ | | | | | |
| | 4 | Untreated | Plasma treatment | 92.1° | 53.1° | 0% | 0 | N/m |
| | | | N₂ (97%) + H₂ (3%) | | | | | |
| | 5 | Plasma treatment | Untreated | 49.5° | 96.3° | 16% | 0 | N/m |
| | | Air | | | | | | |
| | 6 | Plasma treatment | Untreated | 44.5° | 96.3° | 2% | 0 | N/m |
| | | N₂ | | | | | | |
| | 7 | Plasma treatment | Untreated | 55.8° | 96.3° | 1% | 0 | N/m |
| | | N₂ (97%) + H₂ (3%) | | | | | | |
| | 8 | Untreated | UV treatment | 92.1° | 20.0° | 0% | 0 | N/m |
| | | | Wavelength: 172 nm | | | | | |
| | 9 | UV treatment | Untreated | 39.3° | 96.3° | 27% | 0 | N/m |
| | | Wavelength: 172 nm | | | | | | |
| | 10 | UV treatment | UV treatment | 39.3° | 20.0° | 27% | 6.2 | N/m |
| | | Wavelength: 172 nm | Wavelength: 172 nm | | | | | |
| Example | 1 | Plasma treatment | Plasma treatment | 49.5° | 50.5° | 16% | 6.3 | N/m |
| | | Air | Air | | | | | |
| | 2 | Plasma treatment | Plasma treatment | 49.5° | 44.3° | 16% | 8.1 | N/m |
| | | Air | N₂ | | | | | |
| | 3 | Treatment: Plasma | Plasma treatment | 49.5° | 53.1° | 16% | 8.5 | N/m |
| | | treatment Air | N₂ (97%) + H₂ (3%) | | | | | |
| | 4 | Plasma treatment | Plasma treatment | 86.6° | 50.5° | 6% | 2.5 | N/m |
| | | Air | Air | | | | | |
| | 5 | Plasma treatment | Plasma treatment | 44.5° | 50.5° | 2% | 8.8 | N/m |
| | | N₂ | Air | | | | | |
| | 6 | Plasma treatment | Plasma treatment | 44.5° | 44.3° | 2% | 8.1 | N/m |
| | | N₂ | N₂ | | | | | |
| | 7 | Plasma treatment | Plasma treatment | 44.5° | 53.1° | 2% | 7.0 | N/m |
| | | N₂ | N₂ (97%) + H₂ (3%) | | | | | |
| | 8 | Plasma treatment | Plasma treatment | 55.8° | 50.5° | 1% | 6.8 | N/m |
| | | N₂ (97%) + H₂ (3%) | Air | | | | | |
| | 9 | Plasma treatment | Plasma treatment | 55.8° | 44.3° | 1% | 5.9 | N/m |
| | | N₂ (97%) + H₂ (3%) | N₂ | | | | | |
| | 10 | Plasma treatment | Plasma treatment | 55.8° | 53.1° | 1% | 5.0 | N/m |
| | | N₂ (97%) + H₂ (3%) | N₂ (97%) + H₂ (3%) | | | | | |
| Example | 11 | Plasma treatment | Plasma treatment | 79.2° | 89.4° | 2% | 3.1 | N/m |
| | | Ar | Ar | | | | | |
| | 12 | Plasma treatment | Plasma treatment | 83.1° | 23.9° | 2% | 3.6 | N/m |
| | | N₂ | N₂ | | | | | |
| | 13 | Plasma treatment | Plasma treatment | 83.1° | 73.1° | 2% | 3.3 | N/m |
| | | N₂ | N₂ | | | | | |

As described above, water contact angle is an index for the degree of plasma treatment. Thus, the water contact angles of both the formed bodies 1 and 2 were measured after the plasma treatment (“Untreated” corresponds to the water contact angle of a untreated formed body, and “UV treatment” corresponds to the water contact angle of a UV-treated formed body). The water contact angle was measured with a contact angle meter. Specifically, a certain amount of a water droplet was applied onto the surface of a horizontally placed formed body using a dispenser, and the droplet was photographed laterally, followed by analysis of a contour shape based on the resultant image. The results of measurement are shown in Table 1.

<4> Measurement of Dielectric Breakdown Field Strength of Crosslinked Polyrotaxane Formed Body Before and after Plasma Treatment

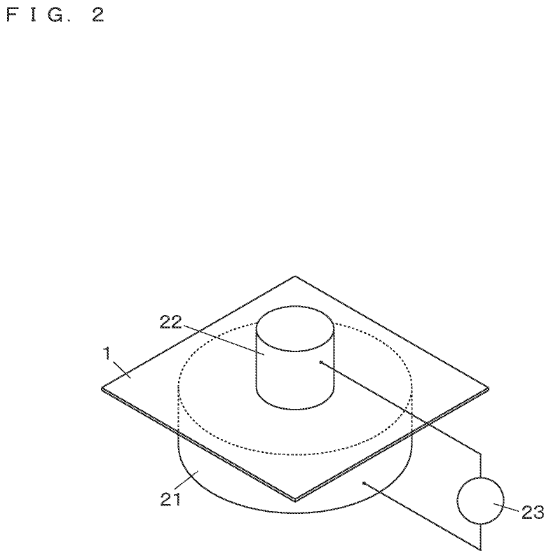

The dielectric breakdown field strength of the crosslinked polyrotaxane formed body 1 was measured at ambient temperature and ambient humidity before and after the plasma treatment in <3> above (“UV treatment” corresponds to values before and after the UV treatment). As shown in FIG. 2, the crosslinked polyrotaxane formed body 1 removed from the aforementioned PET sheet was attached to a disk electrode 21 on a set side, and a cylindrical electrode 22 was placed on the crosslinked polyrotaxane formed body 1 so that the amount of air bubbles remaining between the crosslinked polyrotaxane formed body 1 and the electrodes 21 and 22 was reduced to a minimum possible level, followed by deaeration treatment with a vacuum apparatus. This assembly was set in a dielectric breakdown measurement device at ambient temperature and ambient humidity, and voltage was applied between the electrodes 21 and 22 with a power supply 23 so as to achieve a voltage-increasing rate of 10 V/0.1 seconds. The dielectric breakdown field strength (V/μm) was determined from the voltage at the time when the current was 1.2 μA or more after an insulating state (i.e., substantially no flow of current). The term “ambient temperature” refers to 20 t 15° C., and the term “ambient humidity” refers to 65±20% (cf. JIS-8703, the same shall apply herein). The rate of a reduction in dielectric breakdown field strength by the plasma treatment was calculated. The results are shown in Table 1.

<5> Bonding by Pressure Joining of Crosslinked Polyrotaxane Formed Body and Elastomer Formed Body

The formed bodies 1 and 2 having the PET sheets after the plasma treatment in <3> above were bonded together by pressure joining, to thereby prepare a composite formed body.

As shown in FIG. 1C, a half of the crosslinked polyrotaxane formed body 1 was attached directly to a half of the elastomer formed body 2 without intervention of an inclusion (e.g., an adhesive), and a release paper sheet 3 was disposed between the remaining half of the crosslinked polyrotaxane formed body 1 and the remaining half of the elastomer formed body 2, to thereby form a composite formed body having the PET sheets.

Subsequently, as shown in FIG. 1D, the composite formed body having the PET sheets was applied to a vacuum heating pressing machine 17, and the directly attached halves of the crosslinked polyrotaxane formed body 1 and the elastomer formed body 2 were bonded (pressure-joined) together at a vacuum of 100 Pa or less, a heating temperature of 100° C., and a pressure of 0.67 MPa for five minutes.

<6> Measurement of Peel Strength of Crosslinked Polyrotaxane Formed Body and Elastomer Formed Body

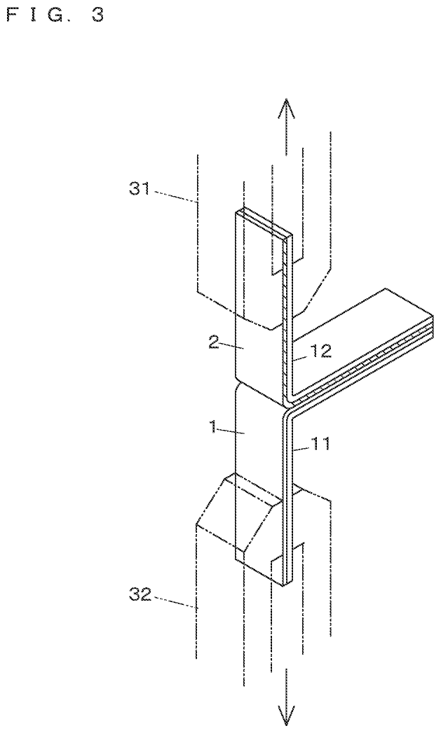

The peel strength of the composite formed body having the PET sheets after the bonding in <5> above was measured with a tensile tester at ambient temperature and ambient humidity. As shown in FIG. 3, the composite formed body having the PET sheets was cut into a piece having a width of 5 mm and a length of 40 mm. A portion (exclusive of the release paper sheet) of the crosslinked polyrotaxane formed body 1 having the PET sheet 11 was gripped by a chuck 31, and a portion (exclusive of the release paper sheet) of the elastomer formed body 2 having the PET sheet 12 was gripped by a chuck 32, followed by pulling at a tensile speed of 1 mm/minute. Thus, a 90° peel test was performed on the bonding portion of the crosslinked polyrotaxane formed body 1 and the elastomer formed body, to thereby measure the peel strength. The results of measurement are shown in Table 1.

<7> Plasma Treatment of Crosslinked Polyrotaxane Formed Body and Additional Crosslinked Polyrotaxane Formed Body and Measurement of Contact Angle

Next will be described the bonding between crosslinked polyrotaxane formed bodies.

In the same manner as in <3> described above, plasma treatment was performed on two surfaces of crosslinked polyrotaxane formed bodies 1 having PET sheets 11 prepared in <1> above.

As shown in Table 2 below, Example 14 wherein plasma treatment was performed with nitrogen (N₂) serving as plasma gas to the same degree as in Examples 5 and 6 shown in Table 1 was compared with Example 15 wherein plasma treatment was performed with nitrogen (N₂) serving as plasma gas to a degree higher than that in Examples 5 and 6 shown in Table 1. Comparative Example 11 corresponds to the case of bonding between untreated crosslinked polyrotaxane formed bodies.

The water contact angle was measured in the same manner as in <3> described above. The results of measurement are shown in Table 2.

TABLE 2

| | Surface Modification Treatment | | | | | |
|---|---|---|---|---|---|---|
| | Crosslinked | Crosslinked | | | Performance | |
| | Polyrotaxane | Polyrotaxane | | | Rate of Reduction in | |
| | Formed Body | Formed Body | | | Dielectric Breakdown | |
| | (Upper: Type of | (Upper: Type of | Water Contact Angle | | Field Strength of | |
| | Treatment | Treatment | Crosslinked | Crosslinked | Crosslinked | |
| | Lower: Type of | Lower: Type of | Polyrotaxane | Polyrotaxane | Polyrotaxane | Peel |
| | Gas, etc.) | Gas, etc.) | Formed Body | Formed Body | Formed Body | Strength |
| Comparative | Untreated | Untreated | 92.1° | 92.1° | 0% | 1.4 N/m |
| Example | | | | | | |
| 11 | | | | | | |
| Example | Plasma treatment | Plasma treatment | 44.5° | 44.5° | 2% | 6.0 N/m |
| 14 | N₂ | N₂ | | | | |
| Example | Plasma treatment | Plasma treatment | 72.5° | 72.5° | 2% | 6.7 N/m |
| 15 | N₂ | N₂ | | | | |

<8> Bonding by Pressure Joining of Crosslinked Polyrotaxane Formed Body and Additional Crosslinked Polyrotaxane Formed Body

The crosslinked polyrotaxane formed bodies 1 having the PET sheets 11 after the plasma treatment in <7> above were bonded together by pressure joining, to thereby prepare a composite formed body.

As shown by replacing the elastomer formed body 2 in FIG. 1C with the crosslinked polyrotaxane formed body, a half of the crosslinked polyrotaxane formed body 1 in FIG. 1A was attached directly to a half of an additional crosslinked polyrotaxane formed body 1 having the same structure without intervention of an inclusion (e.g., an adhesive), and a release paper sheet 3 was disposed between the remaining half of the crosslinked polyrotaxane formed body 1 and the remaining half of the additional crosslinked polyrotaxane formed body 1, to thereby form a composite formed body having the PET sheets.

Subsequently, as shown in FIG. 1D, the composite formed body having the PET sheets was applied to a vacuum heating pressing machine 17, and the directly attached halves of the crosslinked polyrotaxane formed body 1 and the additional crosslinked polyrotaxane formed body were bonded (pressure-joined) together at a vacuum of 100 Pa or less, a heating temperature of 100° C., and a pressure of 0.67 MPa for five minutes.

<9> Measurement of Peel Strength of Crosslinked Polyrotaxane Formed Body and Additional Crosslinked Polyrotaxane Formed Body

In the same manner as in <6> described above, the peel strength of the composite formed body having the PET sheets after the bonding in <8> above was measured with a tensile tester at ambient temperature and ambient humidity. The results of measurement are shown in Table 2.

<10> Preparation of Actuator

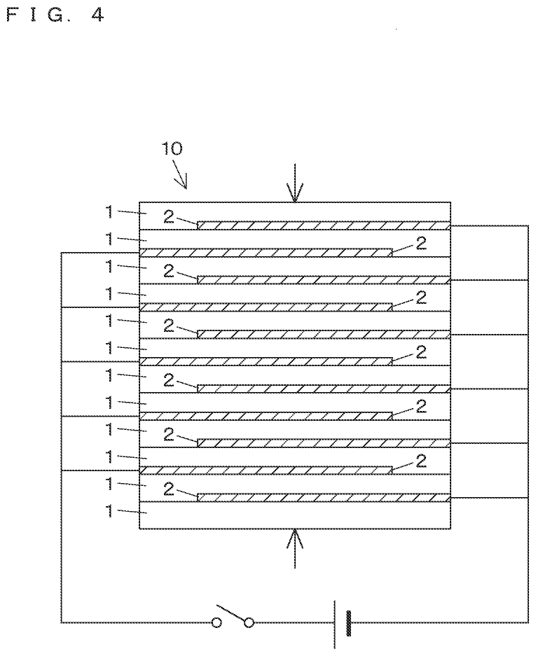

A plurality of plasma-treated crosslinked polyrotaxane formed bodies 1 and plasma-treated elastomer formed bodies 2 of the aforementioned Examples were alternately stacked as shown in FIG. 4, and the stacked formed bodies were bonded together by pressure joining under the same conditions as in <5> described above, to thereby prepare an actuator 10. The elastomer formed bodies 2 serving as electrodes are composed of two groups; i.e., a group of elastomer formed bodies arranged alternately on one side in the horizontal direction, and a group of elastomer formed bodies arranged alternately on the other side in the horizontal direction. When DC voltage is applied to one group serving as a positive electrode and the other group serving as a negative electrode, the crosslinked polyrotaxane formed bodies 1 are contracted in a thickness direction. A change in the total height of the actuator 10 by the contraction can be used as a displacement for driving.

Since the crosslinked polyrotaxane formed bodies 1 are strongly bonded to the elastomer formed bodies 2 in the actuator 10, the actuator can resist a tensile stress applied between the layers caused by contraction of the crosslinked polyrotaxane formed bodies, resulting in reduced layer peeling.

The absence of an adhesive layer between the crosslinked polyrotaxane formed body 1 and the elastomer formed body 2 is more advantageous than the case of the presence of an adhesive layer between these formed bodies in terms of (A) a decrease in the total height of the actuator 10; (B) no loss in the amount of displacement because of the absence of an adhesive layer that restricts the movement of the crosslinked polyrotaxane formed body 1; and (C) an increase in capacitance.

The present invention is not limited to the aforementioned examples, and may be appropriately modified and embodied without departing from the spirit of the invention.

1. A method for producing a polyrotaxane composite formed body, the method comprising subjecting a surface of a crosslinked polyrotaxane formed body and a surface of an elastomer formed body to plasma treatment, and pressure joining the treated surfaces together, to thereby bond the formed bodies.

2. The method for producing a polyrotaxane composite formed body according to claim 1, wherein plasma gas used for the plasma treatment contains substantially no oxygen.

3. The method for producing a polyrotaxane composite formed body according to claim 1, wherein the surface of the plasma-treated crosslinked polyrotaxane formed body exhibits a water contact angle of 90° or less.

4. The method for producing a polyrotaxane composite formed body according to claim 3, wherein the water contact angle is 75° or less.

5. The method for producing a polyrotaxane composite formed body according to claim 1, wherein the formed bodies are heated simultaneously with the pressure joining.

6. The method for producing a polyrotaxane composite formed body according to claim 5, wherein the heating temperature is 50° C. or higher.

7. The method for producing a polyrotaxane composite formed body according to claim 1, wherein the elastomer formed body has electrical conductivity.

8. The method for producing a polyrotaxane composite formed body according to claim 1, wherein the polyrotaxane composite formed body is an actuator or a sensor.

9. A polyrotaxane composite formed body comprising a crosslinked polyrotaxane formed body and an elastomer formed body, wherein these formed bodies are directly bonded together without being intermingled with each other in the absence of an adhesive layer between the formed bodies, an oxygen-rich layer is present between the bonding surfaces of the formed bodies, and the formed bodies exhibit a peel strength of 1 N/m or more.

10. A polyrotaxane composite formed body comprising a crosslinked polyrotaxane formed body and an elastomer formed body, wherein these formed bodies are directly bonded together without being intermingled with each other in the absence of an adhesive layer between the formed bodies, the crosslinked polyrotaxane formed body is modified with a high-affinity functional group, the elastomer formed body is modified with a high-affinity functional group, and the high-affinity functional groups are bonded to each other by covalent bonding or intermolecular interaction at the bonding surfaces of the formed bodies.

11. The polyrotaxane composite formed body according to claim 9, wherein the elastomer formed body has electrical conductivity.

12. The polyrotaxane composite formed body according to claim 9, wherein the polyrotaxane composite formed body is an actuator or a sensor.
